(19) United States
(12) Patent Application Publication
(10) Pub. No.: US 2023/0286878 A1
(43) Pub. Date: Sep. 14, 2023

(54) Composter Device

(71) Applicant: Henry Okolo, Rancho Cucamonga, CA (US)

(72) Inventor: Henry Okolo, Rancho Cucamonga, CA (US)

(21) Appl. No.: 17/871,295

(22) Filed: Jul. 22, 2022

Related U.S. Application Data
(60) Provisional application No. 63/319,280, filed on Mar. 12, 2022.

(51) Int. Cl. C05F 17/964; C05F 17/60; B02C 18/00

(52) U.S. Cl. CPC C05F 17/964; B02C 18/0084; C05F 17/60

(57) ABSTRACT

The present invention relates to a novel composter device. The device is designed to recycle organic waste for easy and convenient disposal. The device comprises a means for grinding organic waste, such as food wastes, yard trimmings, lumber, etc. and a biodegradable bag for collecting the ground organic waste. The device further comprises a button that activates the grinding function and a second button that activates a self-washing function. The device can be sized to handle large or small quantities of waste, depending on the application and setting the device is used in. Accordingly, there may be several versions of the device available to accommodate households, restaurants, schools, farms, ranches, maintenance workers, etc.

### CROSS-REFERENCE TO RELATED APPLICATION

The present application claims priority to, and the benefit of, U.S. Provisional Application No. 63/319,280, which was filed on March 12^{th}, 2022, and is incorporated herein by reference in its entirety.

### FIELD OF THE INVENTION

The present invention relates generally to the field of composters. More specifically, the present invention relates to an improved composter device that provides users with a portable device that grinds organic waste into a biodegradable bag. Accordingly, the present disclosure makes specific reference thereto. Nonetheless, it is to be appreciated that aspects of the present invention are also equally applicable to other like applications, devices and methods of manufacture.

### BACKGROUND

By way of background, composting is the natural process of breaking down organic material into a stable material which can be used as fertilizer. Composting is typically conducted outdoors due to odors and messy liquid byproducts. Composting tends to attract insects and other vermin. Composting can produce large quantities of toxic bacteria. Thus, users may lack the means to recycle their food waste in a simple and convenient manner. Gases generated from improper recycling of biodegradable wastes are environmentally unsafe, contributing to climate degradation. Currently, organic waste is dumped in landfills with no further benefits to mankind. When diverted from landfills into composting and anaerobic digestion facilities, they are transformed into rich soil amendments and biofuel.

A variety of compost devices exist. One type of composting relies on micro-organisms to consume organic waste materials, thereby reducing the volume of the waste material and rendering it safe for handling. The simplest compost devices of this type are stationary or rotating bins that constrain the compost material and aid in manual mixing and air flow. These are intended for use in the backyard or a well-ventilated utility room, for example. More advanced devices may include automatic equipment for mixing and handling compost material while providing air flow. Such devices require special training for operation and maintenance. They generally produce odors and noise. These are intended for industrial use by municipal waste sites, hospitals, schools, prisons, and others.

A variety of tools exist to aid in the composting process. These include buckets to temporarily contain compostable material and reduce odors while awaiting transport to a compost device, compost thermometers, hand mixing tools, sifting screens, and blends of compost micro-organisms and nutritive additives.

What would be desirable is a compost device that may be located near where compostable wastes are produced. Ideally, the compost device may be an indoor device and may emit little or no odor, be automatic, and require little or no maintenance and/or cleaning. It would also be desirable that the device operates with little noise and consumes only a small amount of energy. The device may also be space-efficient, such that it is practical to use in a standard household kitchen.

Therefore, there exists a long-felt need in the art for a composter device that provides users with a system designed to recycle organic waste for easy and convenient disposal. There is also a long-felt need in the art for a composter device that allows users to place food within the system, similar to a garbage disposal, and grind the organic waste into a pulp for recycling. Further, there is a long-felt need in the art for a composter device that includes buttons to activate the grinding system. Moreover, there is a long-felt need in the art for a device that includes buttons to activate the self-washing function, keeping the system clean for future use. Further, there is a long-felt need in the art for a composter device that can be installed underneath a kitchen counter or sink area for easy access when needed. Finally, there is a long-felt need in the art for a composter device that improves environmental consciousness by properly recycling organic waste that could be used for alternative means like fueling trucks, heating homes, etc.

The subject matter disclosed and claimed herein, in one embodiment thereof, comprises a composter device. The device is designed to recycle organic waste for easy and convenient disposal. The device comprises a means for grinding organic waste, such as food wastes, yard trimmings, lumber, etc. and a biodegradable bag for collecting the ground organic waste. The device further comprises a button that activates the grinding function and a second button that activates a self-washing function. The device can be sized to handle large or small quantities of waste, depending on the application and setting the device is used in. Accordingly, there may be several versions of the device available to accommodate households, restaurants, schools, farms, ranches, maintenance workers, etc. Thus, users can grind food, lumber, and/or numerous other organic materials into pulp for additional uses, such as fuel, electricity, etc.

In this manner, the composter device of the present invention accomplishes all of the foregoing objectives and provides users with a device that properly recycles organic waste, which can be used for alternative means like fueling trucks, heating homes, etc. The device allows a user to place food within the device, like a garbage disposal, and grind the organic waste into a pulp for recycling. The device saves time and effort when recycling organic materials.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a composter device. The device is designed to recycle organic waste for easy and convenient disposal. The device comprises a means for grinding organic waste, such as food wastes, yard trimmings, lumber, etc. and a biodegradable bag for collecting the ground organic waste. The device further comprises a button that activates the grinding function and a second button that activates a self-washing function. The device can be sized to handle large or small quantities of waste, depending on the application and setting the device is used in. Accordingly, there may be several versions of the device available to accommodate households, restaurants, schools, farms, ranches, maintenance workers, etc. Thus, users can grind food, lumber, and/or numerous other organic materials into pulp for additional uses, such as fuel, electricity, etc.

In one embodiment, the composter device comprises a housing. The housing may be multi-chambered and configured to be fully automatic and self-contained for indoor use. The housing may be dimensioned to fit within a standard household kitchen cabinet (i.e., a full height cabinet or a portion of the cabinet below a typical drawer with an internal depth of approximately 24″). In another embodiment, the housing can be free-standing and sit beside a kitchen counter on the floor or sit on the kitchen counter itself. The free-standing embodiment can be placed in any suitable room of a user’s house, garage, or outside the house. The housing may be any suitable size as is known in the art, depending on the needs and/or wants of a user, as well as the intended use of the device. For example, the housing could be manufactured larger if the device is meant to be placed outside and be used for grinding lumber or yard trimmings. The housing could be manufactured smaller if the device is meant to be placed under a kitchen cabinet and be used for grinding food wastes.

In one embodiment, the housing may be air sealed to prevent odors from leaking out of the composter device, such that the composter device emits little or no unpleasant odors. The housing may include a layer of thermally insulating material to enable the compost material to reach temperatures necessary for rapid composting. The housing and/or other internal components are preferably constructed of non-corrosive materials, such as aluminum, stainless steel, plastics, etc., due to contact with wet material.

In one embodiment, the housing comprises a lid which can be opened, i.e., hinges upward, to expose the hopper chamber where compostable waste material may be deposited. The lid and hopper may be approximately as long and wide as the overall device, so as to help prevent spilling of waste material outside of the hopper. An initial supply of compost microorganisms is preferably introduced into the device via the hopper. As an example, ordinary outdoor soil may be used as the initial source of compost bacteria. As an alternative, cultured compost bacteria may be alternatively or additionally used. Generally, the micro-organisms reproduce inside the device and remain as long as adequate compost material is present.

In another embodiment, the housing comprises a button or other type of switch that a user presses to activate the grinding function of the device. Further, the button can light up when the hopper chamber is full to signal the user to push the button to activate the grinding function. Although, the user may push the button before the hopper chamber has become full. The composter device may thus provide a simple one-button operation in which activation of the button (or other switch) signals to the device to activate the grinding function.

In another embodiment, the housing comprises an electronic controller in communication with a motor which is used during the grinding function of the device. The electronic controller also comprises a plurality of buttons or other types of switches that signal waste material within the hopper is ready for grinding; that signal the user has cleared a jam; and/or that signal the ground compost needs to be emptied from the composter device, etc., or any other suitable buttons and functions as is known in the art.

In another embodiment, the housing comprises an upper trap door, which opens when the hopper chamber has completed the grinding function and/or when the hopper is full, or when a preset minimum number of days has passed. The electronic controller may optionally also allow the upper trap door to open if a preset maximum amount of time, i.e., 30 minutes, has passed since the previous time that the upper trap door was opened.

To open the upper trap door, a latch, such as a solenoid latch, can be activated by the electronic controller releasing the upper trap door which then falls along with the contents of the hopper by gravity. The waste material in the hopper then falls into a bag positioned directly under the upper trap door. In one embodiment, the bag is biodegradable and can be any suitable size as is known in the art. Further, the upper trap door then closes when the latch is released which pushes the upper trap door back to the closed position. The upper trap door is preferably approximately as long and as wide as the hopper chamber to facilitate material flow from one chamber to the bag.

In another embodiment, the housing comprises a mixing wand or grinding component that mixes and/or grinds the compost material to help break down the material and improve air flow therethrough. In one embodiment, the grinding component may be a single curved rod to help prevent jamming and minimize dead spots where no mixing occurs. Merely as example, the grinding component may be a helical shaped rod, a U-shaped rod, etc. or any other suitable shaped spinning blade as is known in the art. Preferably, the grinding component is configured without a central axle to help prevent any material from grabbing onto the axle and becoming tightened around the grinder with each revolution. Other mixing wand configurations may be employed, such as a mixing paddle or a rotating tumbler, for example, etc.

The shapes of the bottom of the hopper chamber and the grinder (and its path/swath at the bottom of the hopper) are preferably matched, such that the path of the grinder generally follows the bottom of the hopper chamber, so as to minimize any dead spots where no mixing/grinding occurs. As an example, the hopper chamber may have a curved bottom. Additionally, the hopper chamber, the grinder, and the trap door can be angled downward, such that any liquid byproduct from the composting drains down generally in one direction and into the bag. Further, a drain hole may be provided in the hopper chamber to allow fluid to drain from the hopper chamber into the bag. Preferably, the grinder sweeps past the drain hole on the bottom of the hopper with each rotation to prevent or help minimize clogging.

Further, to maintain ideal moisture level of the compost, the grinder may be used to frequently mix the compost, i.e., 1-10 times per day. This allows wet material at the bottom of the hopper chamber to mix with dry material at the top, thereby creating a more uniform and ideal moisture level throughout. Without sufficient mixing, too much fluid may drain into the bag, resulting in the material left in the hopper becoming excessively dry.

As an alternative embodiment, the composter device may be configured, such that the lid is a side opening chute through which items to be composted may be added. The side opening chute may be located on a side of the composter device or on the front of the composter device. Such a configuration may facilitate in allowing the user to add items to be composted while the composter device remains housed within a standard household (i.e., residential) kitchen cabinet. Preferably, the side opening chute is configured with an air trap or air lock, such that items to be composted may be added with a minimum amount of unpleasant odors escaping from the hopper chamber. For example, the air trap may be provided with a rubber gasket to provide a better seal. Additionally, a label and/or other indicia on the lid and/or housing may be provided to summarize directions for usage of the composter device and/or to specify what materials are or are not suitable for composting.

Note that the hopper chamber may retain some of the compost material after each cycle to provide compost bacteria for the next cycle, such that no additional source of cultures needs to be added for subsequent composting cycles.

As is evident, material to be composted is moved from the hopper chamber to the bag by force of gravity. Fluid similarly moves into the bag by force of gravity, preferably without use of pumps or active controls, although such may be provided and utilized depending on the application. Using gravity to move material from one chamber to the next is more efficient and more cost effective than moving material using mechanical conveyor belts or the like. The composter device is thus self-cleaning in that waste material drops down via gravity into the bag. Water condensation dripping down into the bag also facilitates in the cleaning process. In one embodiment, the housing comprises a second button which, when pressed, activates a self-washing function. Typically, the catch bag is replaced with a bucket or other container for catching water. Water is then run through the housing to clean off the grinder and other components. After the clean cycle, the bucket is removed and emptied.

In one embodiment, air flow is used to provide oxygen to the compost micro-organisms and to minimize or prevent unpleasant odors from escaping from the housing. For example, the device can comprise an air pump, i.e., a fan, to draw air into the device, such as via the gap between the lid and the upper most portion of the housing. Alternatively, or additionally, a passive vent may be provided to allow air to flow into the composter device. The air flows down through the hopper chamber and into an air intake tube which can be located at the inside bottom of the housing. The air pump provides the pressure to move the air throughout the device. The air pump can comprise an air filter that facilitates in absorbing odors from the air stream using, for example, an electrostatic filter and/or activated carbon powder. The filtered air is subsequently passed out of the device through an air outlet port, which may be located on the back of the housing, and back into the external environment. The air pump may be controlled by an electronic controller and may be constantly circulating air or can be cycled on and off. An optional heater and/or temperature gauge can be provided to generate heat to facilitate the composting process. The heater and/or temperature gauge may also be controlled by the electronic controller, i.e., a thermostat controller.

Further, the combination of the air flow being exhausted outside of the composter device through the air outlet port and the fluid draining into the bag helps to maintain an ideal moisture level within the composter device, prevents pooling of fluid inside the air filter or the air intake tube, and prevents moisture from condensing on the interior walls of the composter device.

In one embodiment, during usage, baking soda (i.e., a few teaspoons) may be added either manually by the user or automatically into the composting material to help balance the pH of the material to be composted.

In another embodiment, the electronic controller may be in communication with various sensors and with one or more displays for displaying, for example, moisture level (via a moisture level sensor), pH, and/or temperature. Indicator lights on the electronic controller may be provided to inform the user of jamming, mixing, when to empty the finished compost, and/or ready status, etc. In particular, a jam sensor may be provided, such that if the motor stalls (i.e., machine is jammed), power may be pulsed to the motor until the motor breaks free or until a predetermined maximum pulse cycles and/or time has elapsed since the jam was detected. If the jam is not corrected, the jam sensor may then shut off the motor and the jam indicator light may be lit to notify the user of necessary user intervention or correction. The electronic controller preferably automates the composting process. Further, a power supply or a battery (not shown) provides electricity to the electronic controller, air pump, motor, and latch. Further, two opposing handles can be provided to allow for easy positioning and transport of the device by a user. Further, a foot pedal coupled to the lid can be provided to allow for easy hands-free opening of the lid by the user.

Although the composter device may be configured to be suitable for indoor use, the composter device may be weatherproofed. For example, the wiring, electrical components, and/or other sensitive components are preferably mounted above any accumulation of fluid and/or protected from rain or otherwise weatherproofed.

In yet another embodiment, a method of recycling organic waste that can be used for alternative means, such as fueling trucks, heating homes, etc., is described. The method includes the steps of providing a composter device that grinds organic waste into pulp. The method comprises positioning a bag within the device to catch the pulp. The method also comprises inserting organic waste into the device. Further, the method comprises pressing the button that activates the grinding function. The method comprises, retaining the pulp within the bag. The method comprises sealing the bag and removing the bag from the device for recycling. Further, the method comprises pressing the second button to activate the self-washing function. Finally, cleaning the device via the self-washing function with water.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the composter device of the present invention installed underneath a kitchen cabinet in accordance with the disclosed architecture;

FIG. 2 illustrates a perspective view of one embodiment of the composter device of the present invention disclosing food waste being ground into pulp in accordance with the disclosed architecture;

FIG. 3 illustrates a perspective view of one embodiment of the composter device of the present invention wherein the pulp is stored in bags in accordance with the disclosed architecture;

FIG. 4 illustrates a perspective view of one embodiment of the composter device of the present invention wherein the bag is removed from the device in accordance with the disclosed architecture;

FIG. 5 illustrates a perspective view of one embodiment of the composter device of the present invention wherein the system is cleaned with water in accordance with the disclosed architecture; and

FIG. 6 illustrates a flowchart showing the method of recycling organic waste that can be used for alternative means, such as fueling trucks, heating homes, etc., in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a composter device that provides users with a system designed to recycle organic waste for easy and convenient disposal. There is also a long-felt need in the art for a composter device that allows users to place food within the system, similar to a garbage disposal, and grind the organic waste into a pulp for recycling. Further, there is a long-felt need in the art for a composter device that includes buttons to activate the grinding system. Moreover, there is a long-felt need in the art for a device that includes buttons to activate the self-washing function, keeping the system clean for future use. Further, there is a long-felt need in the art for a composter device that can be installed underneath a kitchen counter or sink area for easy access when needed. Finally, there is a long-felt need in the art for a composter device that improves environmental consciousness by properly recycling organic waste that could be used for alternative means like fueling trucks, heating homes, etc.

The present invention, in one exemplary embodiment, is a novel composter device. The device comprises a means for grinding organic waste, such as food wastes, yard trimmings, lumber, etc. and a biodegradable bag for collecting the ground organic waste. The device further comprises a button that activates the grinding function and a second button that activates a self-washing function. The device can be sized to handle large or small quantities of waste, depending on the application and setting the device is used in. The present invention also includes a novel method of recycling organic waste that can be used for alternative means, such as fueling trucks, heating homes, etc. The method includes the steps of providing a composter device that grinds organic waste into pulp. The method comprises positioning a bag within the device to catch the pulp. The method also comprises inserting organic waste into the device. Further, the method comprises pressing the button that activates the grinding function. The method comprises retaining the pulp within the bag. The method comprises sealing the bag and removing the bag from the device for recycling. Further, the method comprises pressing the second button to activate the self-washing function. Finally, cleaning the device via the self-washing function with water.

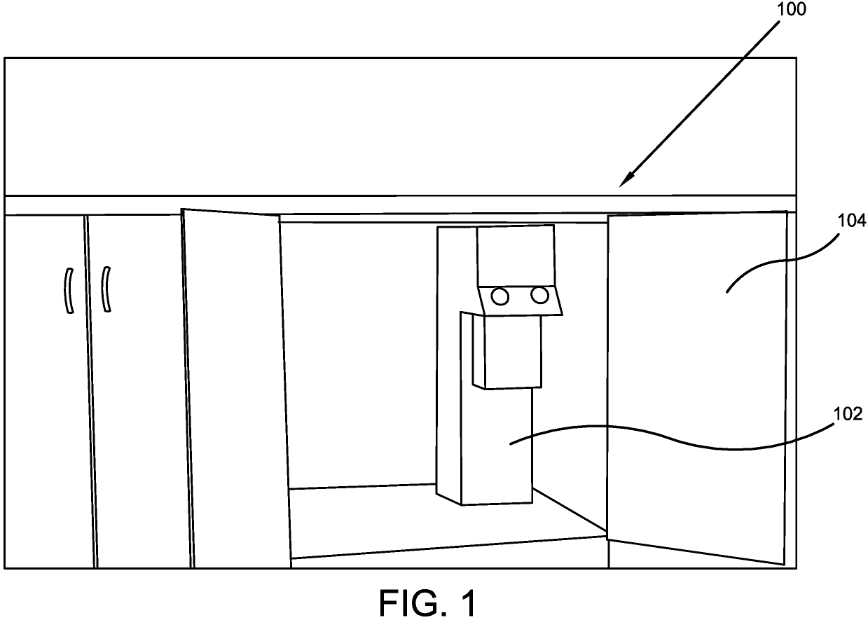

Referring initially to the drawings, FIG. 1 illustrates a perspective view of one embodiment of the composter device 100 of the present invention. In the present embodiment, the composter device 100 is an improved composter device that properly recycles organic waste. The device 100 is especially designed to allow any suitable user as is known in the art to place organic waste within the device 100 and grind the organic waste into a pulp for recycling. More specifically, the device 100 comprises a means for grinding organic waste, such as food wastes, yard trimmings, lumber, etc., and any other suitable wastes as is known in the art, and a biodegradable bag for collecting the ground organic waste. The device 100 further comprises a button that activates the grinding function and a second button that activates a self-washing function. The device 100 can be sized to handle large or small quantities of waste, depending on the application and setting the device 100 is used in. Accordingly, there may be several versions of the device 100 available to accommodate households, restaurants, schools, farms, ranches, maintenance workers, etc.

In one embodiment, the composter device 100 comprises a housing 102. The housing 102 may be multi-chambered and configured to be fully automatic and self-contained for indoor use. The housing 102 may be dimensioned to fit within a standard household kitchen cabinet 104 (i.e., a full height cabinet or a portion of the cabinet below a typical drawer with an internal depth of approximately 24″). In another embodiment, the housing 102 can be free-standing and can sit beside a kitchen counter on the floor or sit on the kitchen counter itself. The free-standing embodiment can be placed in any suitable room of a user’s house, garage, or outside the house. The housing 102 may be any suitable size as is known in the art, depending on the needs and/or wants of a user, as well as the intended use of the device 100. For example, the housing 102 could be manufactured larger if the device 100 is meant to be placed outside and be used for grinding lumber or yard trimmings. The housing 102 could be manufactured smaller if the device 100 is meant to placed under a kitchen cabinet 104 and be used for grinding food wastes.

In one embodiment, the housing 102 may be air sealed to prevent odors from leaking out of the composter device 100, such that the composter device 100 emits little or no unpleasant odors. The housing 102 may include a layer of thermally insulating material to enable the compost material to reach temperatures necessary for rapid composting. The housing 102 and/or other internal components are preferably constructed of non-corrosive materials, such as aluminum, stainless steel, plastics, etc., due to contact with wet material, or any other suitable materials as is known in the art, such as polypropylene, acrylonitrile-butadiene-styrene (ABS), polycarbonate, polyethylene terephthalate, polyvinyl chloride, or polystyrene, etc.

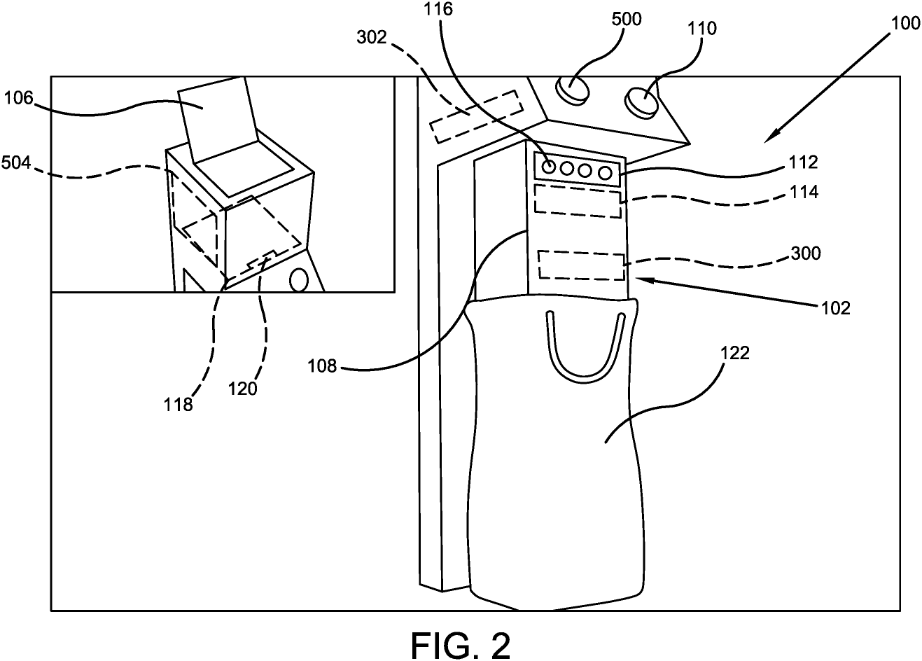

FIG. 2 illustrates a perspective view of another embodiment of the composter device 100 of the present invention. In this embodiment, the housing 102 comprises a lid 106 which can be opened, i.e., hinges upward, to expose the hopper chamber 108 where compostable waste material may be deposited. The lid 106 and hopper 108 may be approximately as long and wide as the overall device 100, so as to help prevent spilling of waste material outside of the hopper 108. In one embodiment, an initial supply of compost microorganisms is introduced into the device 100 via the hopper 108. As an example, ordinary outdoor soil may be used as the initial source of compost bacteria. As an alternative, cultured compost bacteria may be alternatively or additionally used. Generally, the micro-organisms reproduce inside the device 100 and remain as long as adequate compost material is present.

In another embodiment, the housing 102 comprises a grinder button 110 or other type of switch that a user presses to activate the grinding function of the device 100. Further, the grinder button 110 can light up when the hopper chamber 108 is full to signal the user to push the button 110 to activate the grinding function. Although, the user may push the button 110 before the hopper chamber 108 has become full. The composter device 100 may thus provide a simple one-button operation in which activation of the button 110 (or other switch) signals to the device 100 to activate the grinding function.

In another embodiment, the housing 102 comprises an electronic controller 112 in communication with a motor 114 which is used during the grinding function of the device 100. The electronic controller 112 also comprises a plurality of buttons 116 or other types of switches that signal waste material within the hopper 108 is ready for grinding; that signal the user has cleared a jam; and/or that signal the ground compost needs to be emptied from the composter device 100, etc.; or any other suitable buttons and functions as is known in the art.

In another embodiment, the housing 102 comprises an upper trap door 118, which opens when the hopper chamber 108 has completed the grinding function, and/or when the hopper 108 is full, or when a preset minimum number of days has passed. The electronic controller 112 may optionally also allow the upper trap door 118 to open if a preset maximum amount of time, i.e., 30 minutes, has passed since the previous time that the upper trap door 118 was opened.

To open the upper trap door 118, a latch 120, such as a solenoid latch, can be activated by the electronic controller 112 releasing the upper trap door 118 which then falls, along with the contents of the hopper 108, by gravity. The waste material in the hopper 108 then falls into a bag 122 positioned directly under the upper trap door 118. In one embodiment, the bag 122 is biodegradable and can be any suitable size as is known in the art. Further, the upper trap door 118 then closes when the latch 120 is released which pushes the upper trap door 118 back to the closed position. The upper trap door 118 is preferably approximately as long and as wide as the hopper chamber 108 to facilitate material flow from one chamber to the bag 122.

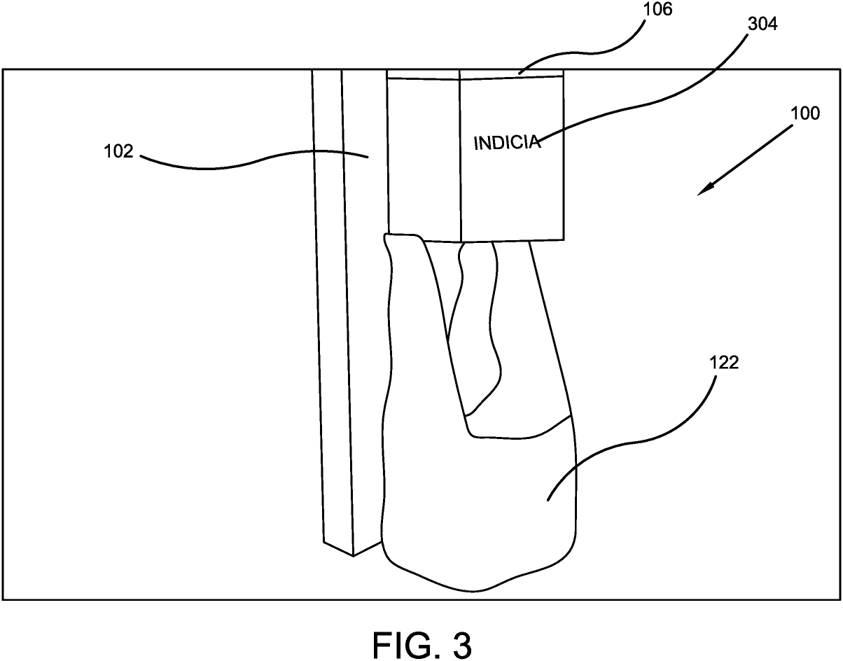

FIG. 3 illustrates a perspective view of another embodiment of the composter device 100 of the present invention. In this embodiment, the housing 102 comprises a mixing wand or grinding component 300 that mixes and/or grinds the compost material to help break down the material and improve air flow therethrough. In one embodiment, the grinding component 300 may be a single curved rod to help prevent jamming and minimize dead spots where no mixing occurs. Merely as example, the grinding component 300 may be a helical shaped rod, a U-shaped rod, etc. or any other suitable shaped spinning blade as is known in the art. Preferably, the grinding component 300 is configured without a central axle to help prevent any material from grabbing onto the axle and becoming tightened around the grinder 300 with each revolution. Other mixing wand configurations may be employed, such as a mixing paddle or a rotating tumbler, for example, etc., or any other suitable configuration as is known in the art.

In another embodiment, the shapes of the bottom of the hopper chamber 108 and the grinder 300 (and its path/swath at the bottom of the hopper 108) are preferably matched such that the path of the grinder 300 generally follows the bottom of the hopper chamber 108, so as minimize any dead spots where no mixing/grinding occurs. As an example, the hopper chamber 108 may have a curved bottom. Additionally, the hopper chamber 108, the grinder 300, and the trap door 118 can be angled downward, such that any liquid byproduct from the composting drains down generally in one direction and into the bag 122. Further, a drain hole (not shown) may be provided in the hopper chamber 108 to allow fluid to drain from the hopper chamber 108 into the bag 122. Preferably, the grinder 300 sweeps past the drain hole on the bottom of the hopper 108 with each rotation to prevent or help minimize clogging.

Further, to maintain ideal moisture level of the compost, the grinder 300 may be used to frequently mix the compost, i.e., 1-10 times per day. This allows wet material at the bottom of the hopper chamber 108 to mix with dry material at the top, thereby creating a more uniform and ideal moisture level throughout. Without sufficient mixing, too much fluid may drain into the bag 122 resulting in the material left in the hopper 108 becoming excessively dry.

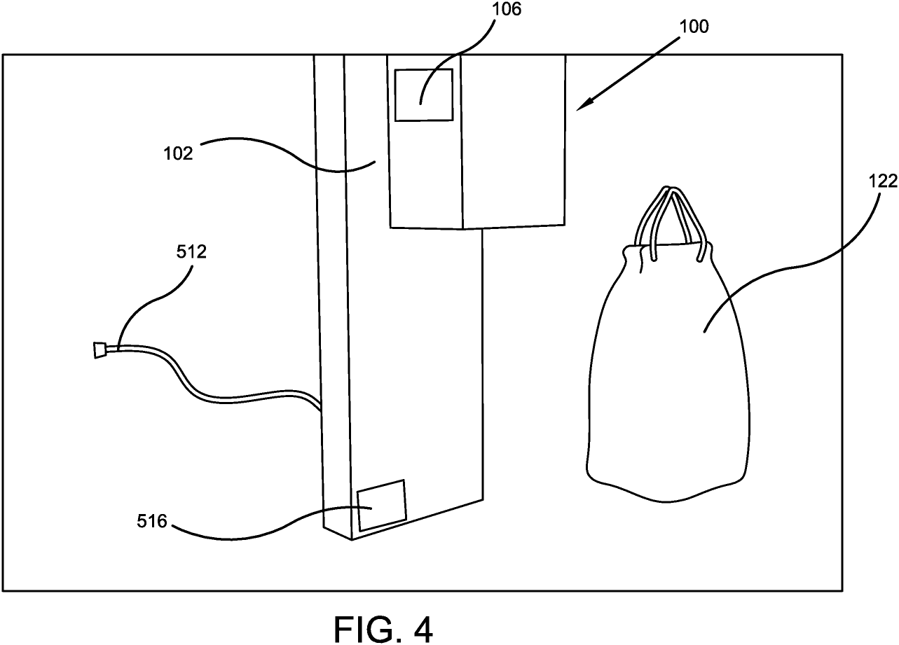

FIG. 4 illustrates a perspective view of another embodiment of the composter device 100 of the present invention. In this embodiment, the composter device 100 may be configured such that the lid 106 is a side opening chute through which items to be composted may be added. The side opening chute (lid 106) may be located on a side of the composter device 100 or on the front of the composter device 100. Such a configuration may facilitate in allowing the user to add items to be composted while the composter device 100 remains housed within a standard household (i.e., residential) kitchen cabinet 104. Preferably, the side opening chute (lid 106) is configured with an air trap or air lock 302, such that items to be composted may be added with a minimum amount of unpleasant odors escaping from the hopper chamber 108. For example, the air trap 302 may be provided with a rubber gasket to provide a better seal. Additionally, a label and/or other indicia 304 on the lid 106 and/or housing 102 may be provided to summarize directions for usage of the composter device 100 and/or to specify what materials are or are not suitable for composting. The device 100 may include advertising, a trademark, or other letters, designs, or characters, printed, painted, stamped, or integrated into the housing 102, or any other indicia 304 as is known in the art. Specifically, any suitable indicia 304 as is known in the art can be included, such as but not limited to, patterns, logos, emblems, images, symbols, designs, letters, words, characters, animals, advertisements, brands, etc., that may or may not be compost or brand related.

Furthermore, the hopper chamber 108 may retain some of the compost material after each cycle to provide compost bacteria for the next cycle, such that no additional source of cultures needs to be added for subsequent composting cycles.

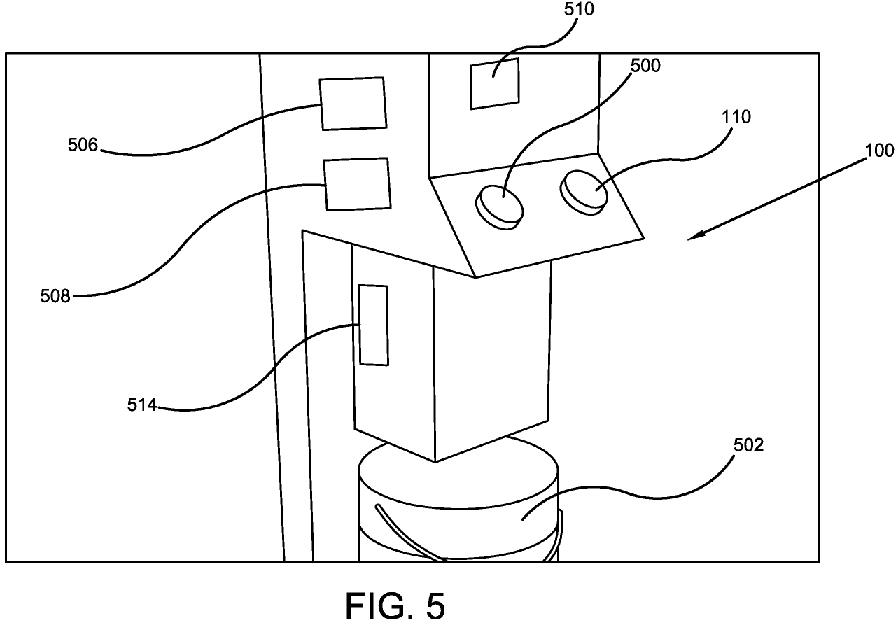

FIG. 5 illustrates a perspective view of another embodiment of the composter device 100 of the present invention. As is evident, material to be composted is moved from the hopper chamber 108 to the bag 122 by force of gravity. Fluid similarly moves into the bag 122 by force of gravity, preferably without use of pumps or active controls, although such may be provided and utilized depending on the application. Using gravity to move material from one chamber to the next is more efficient and more cost effective than moving material using mechanical conveyor belts or the like. The composter device 100 is thus self-cleaning in that waste material drops down via gravity into the bag 122. Water condensation dripping down into the bag 122 also facilitates in the cleaning process. In one embodiment, the housing 102 comprises a second self-washing button 500 which, when pressed, activates a self-washing function. Typically, the catch bag 122 is replaced with a bucket 502 or other container for catching water. Water is then run through the housing 102 to clean off the grinder 300 and other components. After the clean cycle, the bucket 502 is removed and emptied.

In one embodiment, air flow is used to provide oxygen to the compost micro-organisms and to minimize or prevent unpleasant odors from escaping from the housing. For example, the device 100 can comprise an air pump 504, i.e., a fan, to draw air into the device 100, such as via the gap between the lid 106 and the upper most portion of the housing 102. Alternatively, or additionally, a passive vent (not shown) may be provided to allow air to flow into the composter device 100. The air flows down through the hopper chamber 108 and into an air intake tube which can be located at the inside bottom of the housing 102. The air pump 504 provides the pressure to move the air throughout the device 100. The air pump 504 can comprise an air filter that facilitates in absorbing odors from the air stream using, for example, an electrostatic filter and/or activated carbon powder. The filtered air is subsequently passed out of the device 100 through an air outlet port, which may be located on the back of the housing 102, and back into the external environment. The air pump 504 may be controlled by an electronic controller 112 and may be constantly circulating air or can be cycled on and off. An optional heater 506 and/or temperature gauge 508 can be provided to generate heat to facilitate the composting process. The heater 506 and/or temperature gauge 508 may also be controlled by the electronic controller 112, i.e., a thermostat controller.

Further, the combination of air flow exhausting outside of the composter device 100 through the air outlet port and fluid draining into the bag 122 facilitates in maintaining an ideal moisture level within the composter device 100 and in preventing pooling of fluid inside the air filter or the air intake tube and/or in preventing moisture from condensing on the interior walls of the composter device 100.

In one embodiment, during usage, baking soda (i.e., a few teaspoons) may be added either manually by the user or automatically into the composting material to help balance the pH of the material to be composted, or any other suitable material can be added to help balance the pH of the material.

In another embodiment, the electronic controller 112 may be in communication with various sensors and with one or more displays for displaying, for example, moisture level (via a moisture level sensor), pH, and/or temperature. Indicator lights on the electronic controller 112 may be provided to inform the user of jamming, mixing, when to empty the finished compost, and/or ready status, etc. In particular, a jam sensor 510 may be provided, such that if the motor 114 stalls (i.e., machine is jammed), power may be pulsed to the motor 114 until the motor 114 breaks free or until a predetermined maximum pulse cycles and/or time has elapsed since the jam was detected. If the jam is not corrected, the jam sensor 510 may then shut off the motor 114 and the jam indicator light may be lit to notify the user of necessary user intervention or correction. The electronic controller 112 preferably automates the composting process. Further, a power supply 512 or a battery (not shown) provides electricity to the electronic controller 112, air pump 504, motor 114, and latch 120. Further, two opposing handles 514 can be provided to allow for easy positioning and transport of the device 100 by a user. Further, a foot pedal 516 coupled to the lid 106 can be provided to allow for easy hands-free opening of the lid 106 by the user.

Although the composter device 100 may be configured to be suitable for indoor use, the composter device 100 may be weatherproofed. For example, the wiring, electrical components, and/or other sensitive components are preferably mounted above any accumulation of fluid and/or protected from rain or otherwise weatherproofed.

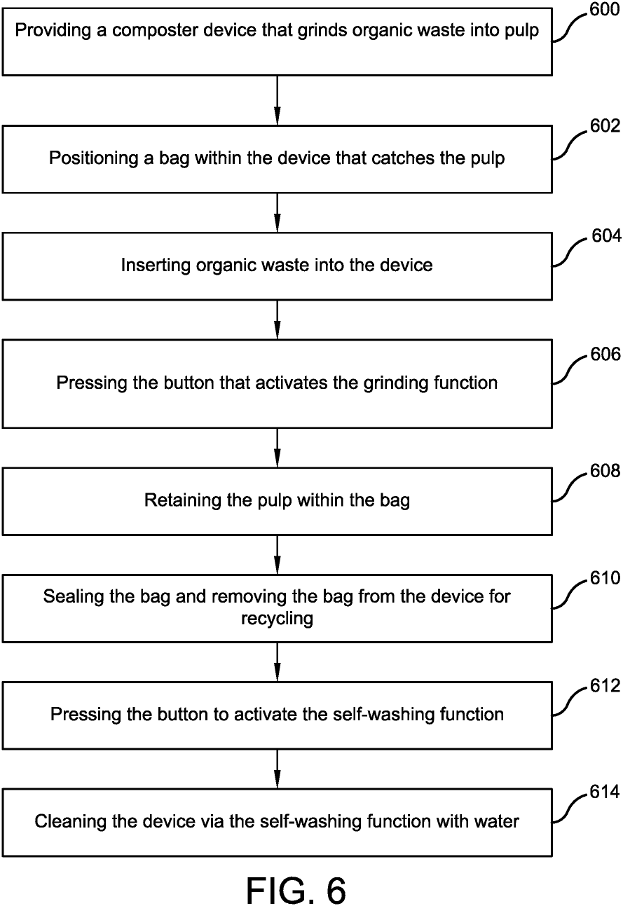

FIG. 6 illustrates a flowchart of the method of recycling organic waste that can be used for alternative means, such as fueling trucks, heating homes, etc. The method includes the steps of at 600, providing a composter device that grinds organic waste into pulp. The method comprises at 602, positioning a bag within the device to catch the pulp. The method also comprises at 604, inserting organic waste into the device. Further, the method comprises at 606, pressing the button that activates the grinding function. The method comprises, at 608, retaining the pulp within the bag. The method comprises at 610, sealing the bag and removing the bag from the device for recycling. Further, the method comprises at 612, pressing the second button to activate the self-washing function. Finally, at 614, cleaning the device via the self-washing function with water.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “composter device” and “device” are interchangeable and refer to the composter device 100 of the present invention.

Notwithstanding the foregoing, the composter device 100 of the present invention can be of any suitable size and configuration as is known in the art without affecting the overall concept of the invention, provided that it accomplishes the above-stated objectives. One of ordinary skill in the art will appreciate that the composter device 100 as shown in FIGS. 1-6 is for illustrative purposes only, and that many other sizes and shapes of the composter device 100 are well within the scope of the present disclosure. Although the dimensions of the composter device 100 are important design parameters for user convenience, the composter device 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A composter device for recycling an organic waste, the composter device comprising:
a housing, wherein the housing encompasses a hopper chamber for retaining the organic waste and an upper trap door that opens when the hopper chamber has completed a grinding function;
a lid, wherein the lid, when opened, exposes the hopper chamber;
a grinding component that grinds the organic waste;
a motor; and
an electronic controller in communication with the motor and the grinding component, wherein the organic waste placed in the hopper chamber falls into a bag positioned directly underneath the hopper chamber, once the organic waste has been ground by the grinding component.

2. The composter device of claim 1, wherein the composter device is sized and configured to fit within a kitchen cabinet.

3. The composter device of claim 1, wherein the composter device is a free-standing device.

4. The composter device of claim 1, wherein the housing is air sealed to prevent odors from leaking out.

5. The composter device of claim 1, wherein the housing comprises a grinder button which activates the grinding function.

6. The composter device of claim 1, wherein the upper trap door comprises a latch activated by the electronic controller.

7. The composter device of claim 1, wherein the bag is biodegradable.

8. The composter device of claim 1, wherein the lid is positioned on a side of the housing.

9. The composter device of claim 1, wherein the lid is positioned on a top of the housing.

10. The composter device of claim 1, wherein the housing comprises an indicia.

11. The composter device of claim 1, wherein the housing comprises a self-washing button that activates a self-washing function.

12. The composter device of claim 11, wherein the bag is replaced with a bucket when the self-washing function is utilized.

13. The composter device of claim 1, wherein the electronic controller comprises a temperature gauge.

14. The composter device of claim 1, wherein the electronic controller comprises a heater.

15. The composter device of claim 1, wherein the electronic controller comprises an air pump.

16. A composter device for recycling an organic waste, the composter device comprising:
a housing comprising a hopper chamber for retaining the organic waste, an upper trap door that opens when the hopper chamber has completed a grinding function, an air pump to draw a quantity of air into the housing, and an air filter;
a lid that when opened exposes the hopper chamber;
a grinding component that grinds the organic waste during the grinding function;
a motor; and
an electronic controller in communication with the motor and the grinding component;
a bag positioned directly underneath the hopper chamber to catch the organic waste once ground by the grinding component, wherein the housing further comprises a grinder button that activates the grinding function and a self-washing button that activates a self-washing function.

17. The composter device of claim 16, wherein the air filter is an electrostatic filter.

18. The composter device of claim 16, wherein the air filter is an activated carbon powder.

19. The composter device of claim 1, wherein the housing comprises an indicia.

20. A method of recycling an organic waste comprising the steps of:
providing a composter device that grinds the organic waste into a pulp;
positioning a bag relative to the composter device to catch the pulp;
inserting the organic waste into the composter device;
pressing a first button that activates a grinding function of the composer device;
retaining the pulp within the bag;
sealing the bag;
removing the bag from the composter device for recycling; and
pressing a second button to activate a self-washing function.
